(19) United States
(12) Patent Application Publication
(10) Pub. No.: US 2023/0077877 A1
(43) Pub. Date: Mar. 16, 2023

(54) PHOTONIC PACKAGE AND METHOD OF MANUFACTURING THE SAME

(71) Applicant: Advanced Semiconductor Engineering, Inc., Kaohsiung (TW)

(72) Inventors: Cheng-Yuan KUNG, Kaohsiung (TW); Hung-Yi LIN, Kaohsiung (TW)

(73) Assignee: Advanced Semiconductor Engineering, Inc., Kaohsiung (TW)

(21) Appl. No.: 17/472,348

(22) Filed: Sep. 10, 2021

(51) Int. Cl. G02B 6/42

(52) U.S. Cl. CPC G02B 6/4239; G02B 6/4212; G02B 6/4249; G02B 6/4238; H04B 10/25

(57) ABSTRACT

A photonic package and a method of manufacturing a photonic package are provided. The photonic package includes a carrier, an electronic component, and a photonic component. The carrier has a first surface and a recess portion exposed from the first surface. The electronic component is disposed in recessed portion. The photonic component is disposed on and electrically connected to the electronic component and is configured to communicate optical signals.

### BACKGROUND

### 1. Technical Field

The present disclosure relates generally to a photonic package and a method of manufacturing a photonic package.

### 2. Description of the Related Art

A chip-on-chip (CoC) package usually includes two electronic components stacked on each other. The stacked electronic components are in electrical communication with each other through bond wires. The bond wires, however, have high resistance and long transmission paths. Therefore, CoC packages usually suffer from signal integrity issues, particularly in high frequency applications. In addition, the limitation of conventional wire bonding signal transmission is that the high impedance caused by the extended transmission path prevents high speed data rates, for example, 100 Gbit/s, 400 Gbit/s, or 1.6 Tbit/s, from being realized. Moreover, silicon photonics and optical engines usually require high speed data rates with the integration of at least an electronic IC (EIC) and a photonic IC (PIC).

In light of the above, electronic ICs or dies may be formed in a package followed by each of the electronic ICs or dies flip-chip bonding to a photonic IC or die. For example, the electronic ICs and the photonic IC may be stacked on one another. However, this type of stacked structure raises additional issues.

### SUMMARY

In one or more embodiments, a photonic package includes a carrier, an electronic component, and a photonic component. The carrier has a first surface and a recess portion exposed from the first surface. The electronic component is disposed in recessed portion. The photonic component is disposed on and electrically connected to the electronic component and is configured to communicate optical signals.

In one or more embodiments, a photonic package includes a carrier, a first electronic component, a second electronic component, and a photonic component. The first electronic component is disposed in the carrier. The second electronic component is disposed in the carrier. A thickness of the first electronic component is different from a thickness of the second electronic component. The photonic component is disposed on the carrier, electrically connected to the first electronic component and the second electronic component, and configured to communicate optical signals.

In one or more embodiments, a photonic package includes a carrier, a first electronic component, and a second electronic component. The carrier includes at least one cavity exposed from an upper surface of the carrier. The first electronic component is disposed in the at least one cavity of the carrier. The first electronic component is configured to control modulation of optical signals. The second electronic component is disposed in the at least one cavity of the carrier. The second electronic component is configured to amplify electrical signals.

### BRIEF DESCRIPTION OF THE DRAWINGS

Aspects of the present disclosure are best understood from the following detailed description when read with the accompanying drawings. It is noted that various features may not be drawn to scale, and the dimensions of the various features may be arbitrarily increased or reduced for clarity of discussion.

FIG. 1 illustrates a cross-sectional view of a photonic package in accordance with some embodiments of the present disclosure;

FIG. 2A illustrates a top view of a photonic package in accordance with some embodiments of the present disclosure;

FIG. 2B illustrates a top view of a photonic package in accordance with some embodiments of the present disclosure;

FIG. 3A illustrates a cross-sectional view of a photonic package in accordance with some embodiments of the present disclosure;

FIG. 3B illustrates a cross-sectional view of a photonic package in accordance with some embodiments of the present disclosure;

FIG. 4 illustrates a cross-sectional view of a photonic package in accordance with some embodiments of the present disclosure;

FIG. 5A illustrates a cross-sectional view of a photonic package in accordance with some embodiments of the present disclosure;

FIG. 5B illustrates a cross-sectional view of a photonic package in accordance with some embodiments of the present disclosure; and

FIG. 6A, FIG. 6A1, FIG. 6B, FIG. 6C, FIG. 6D, and FIG. 6E illustrate various operations in a method of manufacturing a photonic package in accordance with some embodiments of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

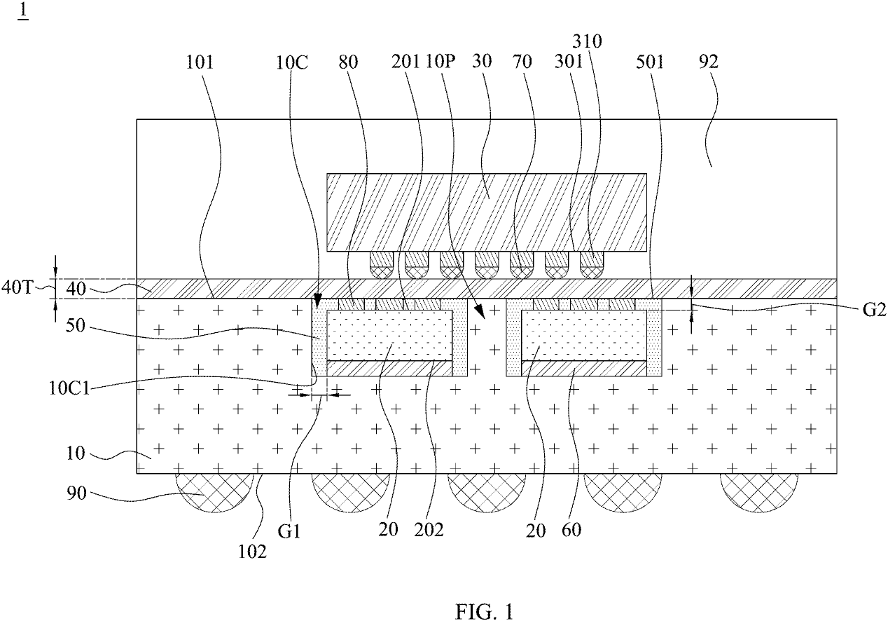

FIG. 1 illustrates a cross-sectional view of a photonic package 1 in accordance with some embodiments of the present disclosure. The photonic package 1 includes a carrier 10, electronic components 20, a photonic component 30, a redistribution layer (RDL) 40, a filling material 50, an adhesive layer 60, conductive elements 70 and 80, electrical contacts 90, and an encapsulant 92.

The carrier 10 may have a surface 101 (also referred to as “an upper surface”) and a surface 102 (also referred to as “a bottom surface”) opposite to the surface 101. In some embodiments, the carrier 10 includes a recess portion exposed from the surface 101 of the carrier 10. In some embodiments, the recess portion of the carrier 10 includes a cavity 10C. In some embodiments, the recess portion of the carrier 10 may include a space or through hole passing through the carrier 10 from the surface 101 to the surface 102. In some embodiments, the carrier 10 includes a plurality of recess portions (e.g., cavities 10C) exposed from the surface 101 of the carrier 10. In some embodiments, the plurality of recess portions may include one or more cavities and one or more through holes. In some embodiments, the carrier 10 includes a partition wall 10P between the cavities 10C. In some embodiments, the cavities 10C are spaced apart from each other by the partition wall 10P. In some embodiments, the cavities 10C are spaced apart from the surface 102 of the carrier 10. The carrier 10 may be, for example, a printed circuit board, such as a paper-based copper foil laminate, a composite copper foil laminate, or a polymer -impregnated glass-fiber-based copper foil laminate. The carrier 10 may include an interconnection structure, such as a plurality of conductive traces and/or conductive through vias. The carrier 10 may include a substrate, such as an organic substrate or a leadframe. The carrier 10 may include a two-layer or multi-layer substrate which includes a core layer and a conductive material and/or structure disposed on an upper surface and a bottom surface of the carrier 10. The carrier 10 may include an interposer. The carrier 10 may include one or more conductive pads (not shown) in proximity to, adjacent to, or embedded in and exposed at the surface 101 of the carrier 10. The carrier 10 may include one or more conductive pads (not shown) in proximity to, adjacent to, or embedded in and exposed at the surface 102 of the carrier 10. The carrier 10 may include a solder resist (not shown) on the surface 102 of the carrier 10 to fully expose or to expose at least a portion of the conductive pads for electrical connections. In some embodiments, a line/space (L/S) of the interconnection structure or the conductive pads (not shown) of the carrier 10 may be about 25 µm/25 µm. In some embodiments, a pitch of the interconnection structure or the conductive pads (not shown) of the carrier 10 is from about 40 µm to about 60 µm. In some embodiments, a pitch of the interconnection structure or the conductive pads (not shown) of the carrier 10 is about 50 µm.

The electronic component 20 may be disposed in the carrier 10. In some embodiments, the electronic component 20 is disposed in the recess portion of the carrier 10. The electronic component 20 may be disposed below the surface 101 of the carrier 10. In some embodiments, the electronic component 20 is embedded in the carrier 10. In some embodiments, the electronic component 20 is disposed in the cavity 10C. In some embodiments, the electronic component 20 is entirely in the cavity 10C. In some embodiments, the electronic component 20 is spaced apart from a sidewall 10C1 of the cavity 10C by a gap G1. In some embodiments, the electronic component 20 has an active surface 201 exposed from the surface 101 of the carrier 10. In some embodiments, the electronic component 20 further has an inactive surface 202 opposite to the active surface 201. In some embodiments, the surface 101 of the carrier 10 and the active surface 201 of the electronic component 20 are at different elevations. In some embodiments, the active surface 201 of the electronic component 20 is at an elevation lower than the surface 101 of the carrier 10. In some embodiments, the photonic package 1 may include a plurality of electronic components 20 disposed in one or multiple cavities 10C of the carrier 10. In some embodiments, each of the electronic components 20 is disposed in one of the cavities 10C of the carrier 10. In some embodiments, the electronic component 20 includes an electronic integrated circuit (EIC) or an electronic die. In some embodiments, the electronic component 20 is configured to control modulation of optical signals. In some embodiments, the electronic component 20 is configured to amplify electrical signals. In some embodiments, one of the electronic components 20 is configured to control modulation of optical signals, and the other one of the electronic components 20 is configured to amplify electrical signals. In some embodiments, the electronic component 20 is configured to control an optical modulator. In some embodiments, the electronic component 20 is configured to amplify electrical signals received from the photonic component 30, for example, a photodetector of the photonic component 30. In some embodiments, the photo-detector is configured to convert optical signals to electrical signals. In some embodiments, the electronic component 20 may include a modulator driver (DRV), a trans-impedance amplifier (TIA), or a combination thereof. In some embodiments, the electronic component 20 may include one or more active devices, one or more passive circuit components, and electrically conductive paths interconnecting the active devices and the passive circuit components in electrical circuit relationships for performing a desired sub-circuit control function.

The photonic component 30 may be disposed on the carrier 10. The photonic component 30 may be disposed adjacent to the surface 101 of the carrier 10. In some embodiments, the photonic component 30 may be disposed on and electrically connected to the electronic component 20. In some embodiments, the photonic component 30 may include one or more conductive pads 310 in proximity to, adjacent to, or embedded in and exposed at an active surface 301 of the photonic component 30 for electrical connections. In some embodiments, the photonic component 30 is configured to communicate optical signals (or modulated optical signals). For example, the photonic component 30 may be configured to transmit or receive optical signals. In some embodiments, the photonic component 30 includes a an optical component (e.g., a waveguide) configured to transmit optical signals (e.g., light), for example, received from a laser diode, an optical fiber or an optical fiber array. In some embodiments, the photonic component 30 includes a photonic integrated circuit (PIC) or a photonic die. In some embodiments, the photonic component 30 may include a laser diode, a receiver, a waveguide, a photodetector, a photodiode, a semiconductor optical amplifier (SOA), a grating coupler, a fiber coupling structure, an optical modulator (e.g., Mach-Zehnder modulator or microring modulator), or a combination thereof. For example, the photonic component 30 may include a combination of photonic devices in a circuit and other active and passive optical devices on a single substrate to achieve a desired function.

In some embodiments, the electronic components 20 and the photonic component 30 in the photonic package 1 may realize high speed signal transmission, for example, greater than 400 Gbit/s. For example, the electronic component 20 may transmit electrical signals to the photonic component 30 (e.g., an optical modulator of the photonic component 30) such that the optical signals (e.g., light from a laser diode) in the photonic component 30 can be modulated for further transmission to an external optical component. For example, an optical signal is received by the photonic component 30 and converted into an electrical signal, and then the electrical signal is sent to the electronic component 20 for amplification. In the present disclosure, the signal transmission path between the electronic components 20 and the photonic component 30 can be shorten and can be designed in the photonic package 1 to have suitable impedance allowing the aforesaid high speed signal transmission. In some embodiments, high speed signal transmission, for example, may possess a data rate of about 100 Gbit/s, 400 Gbit/s, or 1.6 Tbit/s. In addition, since in the present disclosure the signal transmission path between the electronic components 20 and the photonic component 30 is shorten, the issues, such as signal distortion or signal strength weakening, which are known to occur under high data rate transmission can be alleviated.

The RDL 40 may be disposed over the carrier 10. In some embodiments, the RDL 40 directly or physically contacts the surface 101 of the carrier 10. In some embodiments, the RDL 40 is disposed over the electronic component 20. In some embodiments, the active surface 201 of the electronic component 20 is electrically connected to the RDL 40. In some embodiments, the electronic component 20 is electrically connected to the carrier 10 through the RDL 40. In some embodiments, the inactive surface 202 of the electronic component 20 is electrically isolated from the carrier 10. In some embodiments, the active surface 201 of the electronic component 20 is electrically connected to the RDL 40 and spaced apart from the RDL 40 by a gap G2. In some embodiments, the gap G1 is connected to the gap G2. In some embodiments, and electronic component 20 and the photonic component 30 are disposed on two opposite sides of the RDL 40. In some embodiments, the photonic component 30 is electrically connected to the electronic component 20 through the RDL 40.

In some embodiments, a line/space (L/S) of conductive traces of the RDL 40 is less than that of the carrier 10. In some embodiments, a pitch of conductive pads or bumps of the RDL 40 is less than that of the carrier 10. In some embodiments, a line/space (L/S) of conductive traces of the RDL 40 may be about 2 µm/2 µm. In some embodiments, a pitch of conductive pads or bumps of the RDL 40 is from about 3 µm to about 5 µm. In some embodiments, a pitch of conductive pads or bumps of the RDL 40 is about 4 µm. In some embodiments, the RDL 40 includes one conductive patterned layer (i.e., a single layer of conductive patterns). In some embodiments, the RDL 40 includes two conductive patterned layers electrically connected to each other through conductive via(s). In some embodiments, the RDL 40 includes three or less than three layers of conductive patterns. In some embodiments, a thickness 40T of the RDL 40 is from about 1 µm to about 5 µm. In some embodiments, the carrier 10 together with the RDL 40 form a fan-out substrate.

In current photonics engine structures, electronic components (e.g., EICs) are stacked on a substrate, and a photonic component (e.g., a PIC) is further stacked on and electrically connected to the electronic components. The stacked structure may be beneficial to reduce the surface area of the substrate required for accommodating the photonic component and the photonic component; however, this type of stacked structure has a relatively large thickness. In addition, a high-density electrical connection with a relatively narrow L/S or small pitch is required due to the high input/output (I/O) count for the electronic components (e.g., the EICs). The L/S or pitch of the substrate (e.g., a PCB or an interposer) is usually too wide or large to fit the high-density electrical connection needs of the electronic components (e.g., the EICs). On the other hand, a multi-layered redistribution structure, e.g., including over four, five, or six RDL layers, may serve as a substrate in the aforesaid stacked structure to obtain a satisfactory L/S or pitch for the high-density electrical connection to the electronic components (e.g., the EICs); however, the manufacturing time for the multi-layered redistribution structure is relatively long, and the costs are relatively high.

According to some embodiments of the present disclosure, the electronic component 20 is disposed below the upper surface (i.e., the surface 101) of the carrier 10 (e.g., embedded in the carrier 10), rather than stacked over the carrier 10, such that the overall thickness of the photonic package 1 can be significantly reduced.

In addition, according to some embodiments of the present disclosure, the RDL 40 can be relatively thin and provided with a relatively high I/O count for the electronic component 20, and thus the high-density electrical connection between the electronic component 20 and the carrier 10 or between the electronic component 20 and the photonic component 30 can be realized by the RDL 40. Therefore, the overall thickness of the photonic package 1 can be reduced, the relatively long cycle time as well as the cost for forming the carrier 10 as a multi-layered redistribution structure can be omitted, and the high-density electrical connection requirement for the electronic component 20 can be achieved.

Moreover, according to some embodiments of the present disclosure, the carrier 10 includes a plurality of cavities 10C defined by the partition wall 10P, and thus the partition wall 10P can serve as an alignment assisting structure in the pick and place operation of the electronic components 20. Therefore, the alignment accuracy of the pick and place operation of the electronic components 20 can be increased, each of the electronic components 20 can be disposed in each one of the cavities 10C of the carrier 10 more accurately, damages caused by collisions between the electronic components 20 during the pick and place operation can be effectively prevented, and thus the yield can be increased.

The conductive elements 80 may electrically connect the RDL 40 and the electronic component 20. In some embodiments, the conductive elements 80 directly or physically contact the RDL 40 and the active surface 201 of the electronic component 20. In some embodiments, the conductive elements 80 are disposed within the gap G2. In some embodiments, a thickness of the conductive elements 80 is substantially equal to a height of the gap G2. In some embodiments, the conductive elements 80 include conductive pillars, conductive studs, and/or conductive pads. The conductive elements 80 may be or include gold (Au), silver (Ag), copper (Cu), nickel (Ni), another metal, or a combination of two or more thereof. In some embodiments, a pitch of the conductive elements 80 is from about 25 µm to about 55 µm. In the cases where the RDL 40 is omitted, the conductive elements connected to the electronic component 20 through the carrier 10 may have a relatively large pitch from about 80 µm to about 150 µm. According to some embodiments of the present disclosure, the arrangement of the RDL 40 can significantly reduce the pitch of the conductive elements 80 and thus satisfy the relatively high I/O count requirement for the electronic component 20.

The filling material 50 may be disposed in the cavity 10C of the carrier 10. In some embodiments, a surface 501 (also referred to as “an upper surface”) of the filling material 50 is substantially aligned with the surface 101 of the carrier 10. In some embodiments, the surface 501 of the filling material 50 is substantially coplanar with the surface 101 of the carrier 10. In some embodiments, the filling material 50 is disposed in the gap G1. In some embodiments, the filling material 50 is disposed in the gap G2. In some embodiments, the filling material 50 fills in the spaces (i.e., portions of the gap G2) between the conductive elements 80. In some embodiments, the filling material 50 includes a portion filled in the gap G1 and a portion filled in the gap G2, and these portions in the gap G1 and the gap G2 are connected to each other. In some embodiments, the filling material 50 directly or physically contacts the conductive elements 80. In some embodiments, the filling material 50 encapsulates the electronic component 20. In some embodiments, the filling material 50 directly or physically contacts the RDL 40 and a portion of the active surface 201 of the electronic component 20. In some embodiments, the filling material 50 includes an epoxy resin, a molding compound (e.g., an epoxy molding compound or other molding compound), polyimide, a phenolic compound or material, or a combination thereof. In some embodiments, the filling material 50 includes an underfill.

The adhesive layer 60 may be between a bottom surface of the cavity 10C and the inactive surface 202 of the electronic component 20. In some embodiments, the adhesive layer 60 directly or physically contacts the bottom surface of the cavity 10C and the inactive surface 202 of the electronic component 20. In some embodiments, the adhesive layer 60 directly or physically contacts the filling material 50. In some embodiments, the adhesive layer 60 may be or include a die attach film (DAF). In some embodiments, the adhesive layer 60 may include a thermal interface material (TIM). In addition to adhering the electronic component 20 to the carrier 10, heat generated from the electronic component 20 can be conducted through the TIM and through vias of the carrier 10 toward at least one of the electrical contacts 90, and thus the adhesive layer 60 including or formed of TIM can further provide enhanced heat dissipation for the electronic component 20.

The conductive elements 70 may electrically connect the RDL 40 and the photonic component 30. In some embodiments, the conductive elements 70 electrically connect the active surface 301 of the photonic component 30 to the RDL 40. In some embodiments, the conductive elements 70 directly or physically contact the RDL 40 and the active surface 301 of the photonic component 30. In some embodiments, the conductive elements 70 directly or physically contact the RDL 40 and the conductive pads 310 of the photonic component 30. In some embodiments, the conductive elements 70 include conductive bumps. The conductive bumps may be or include gold (Au), silver (Ag), copper (Cu), nickel (Ni), another metal, a solder alloy, or a combination of two or more thereof. In some embodiments, a pitch of the conductive elements 70 is from about 25 µm to about 55 µm. In the cases where the RDL 40 is omitted, the conductive elements connected to the photonic component 30 may have a relatively large pitch from about 80 µm to about 150 µm. According to some embodiments of the present disclosure, the arrangement of the RDL 40 can significantly reduce the pitch of the conductive elements 70 and thus satisfy the relatively high I/O count requirement for the electrical connection between the electronic component 20 and the photonic component 30. In some other embodiments, the RDL 40 and the photonic component 30 may be bonded through a hybrid bonding (not shown in drawings); in such embodiment, a conductive layer and a dielectric structure around or surrounding the conductive layer of the photonic component 30 contact a conductive layer and a dielectric structure around or surrounding the conductive layer of the RDL 40 respectively.

The electrical contacts 90 may be connected to the surface 102 of the substrate 10. The electrical contact 90 can provide electrical connections between the photonic package 1 and external components (e.g., external circuits or circuit boards). In some embodiments, a pitch of the electrical contacts 90 is from about 350 µm to about 400 µm. In some embodiments, the electrical contacts 90 include solder balls. In some embodiments, the electrical contacts 90 include controlled collapse chip connection (C4) bumps, a ball grid array (BGA), or a land grid array (LGA).

The encapsulant 92 may encapsulate the photonic component 30. In some embodiments, the encapsulant 92 directly or physically contacts the RDL 40. In some embodiments, the encapsulant 92 directly or physically contacts the conductive elements 70 and the conductive pads 310 of the photonic component 30. In some embodiments, the encapsulant 92 may include an epoxy resin having fillers, a molding compound (e.g., an epoxy molding compound or other molding compound), polyimide, a phenolic compound or material, a material with a silicone dispersed therein, or a combination thereof.

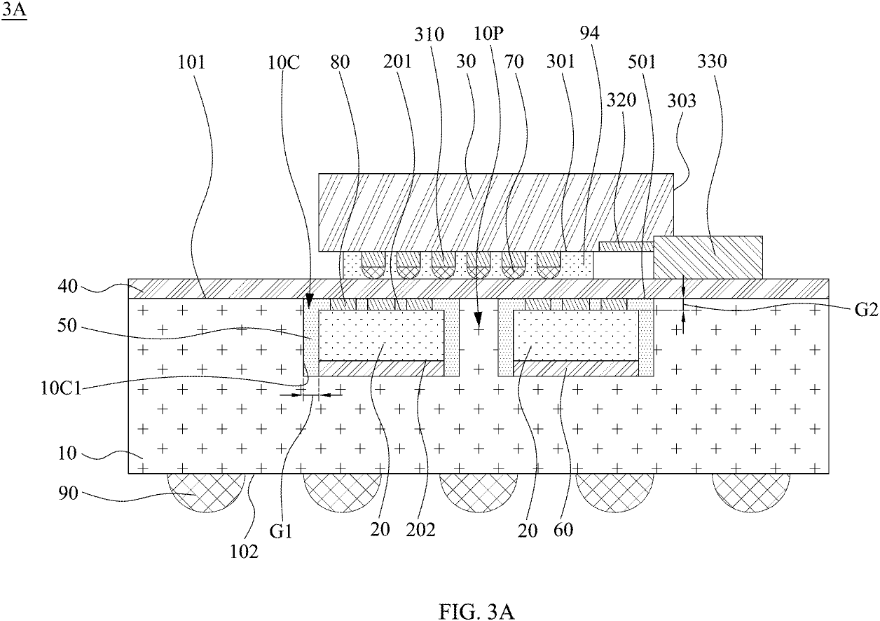

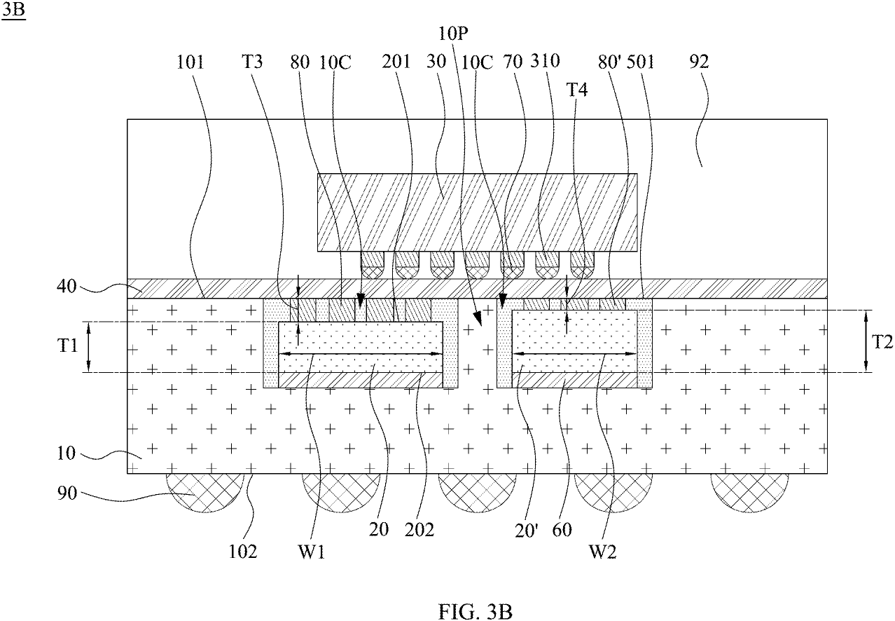

In some embodiments, although not shown in FIG. 1, the photonic component 30 may include an optical component, such as the optical component 320 (e.g., waveguide) as shown in FIG. 3A. The details of the optical component 320 are disclosed hereinafter. In some embodiment, a portion of the encapsulant 92 may be absent so that a portion of a photonic component 30 is exposed from the encapsulant 92 to couple with an optical component, such as the optical component 330 (e.g., an optical fiber array unit) as shown in FIG. 3A. The details of the optical component 320 are disclosed hereinafter. In some embodiments, a portion of the encapsulant 92 may be removed to expose at least a portion of a back surface of the photonic component 30, so as to crease a space for accommodating the optical component. The back surface of the photonic component 30 is opposite to the active surface 301 of the photonic component 30. The portion of the encapsulant 92 may be removed by, for example, grinding or other suitable operations. In some embodiments, the optical component (e.g., the optical fiber array unit) may be disposed on the back surface of the photonic component 30 and optically coupled to the waveguide of the photonic component 30. In some embodiments, a waveguide may be exposed from the back surface of the photonic component 30 or may be located at the active surface 301 of the photonic component 30 and optically communicate to the back surface of the photonic component 30, so as to optically couple to the optical fiber array unit.

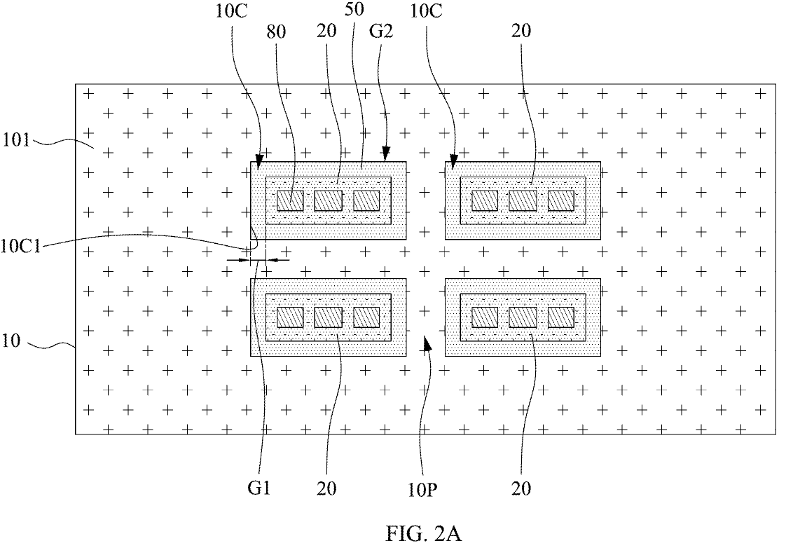

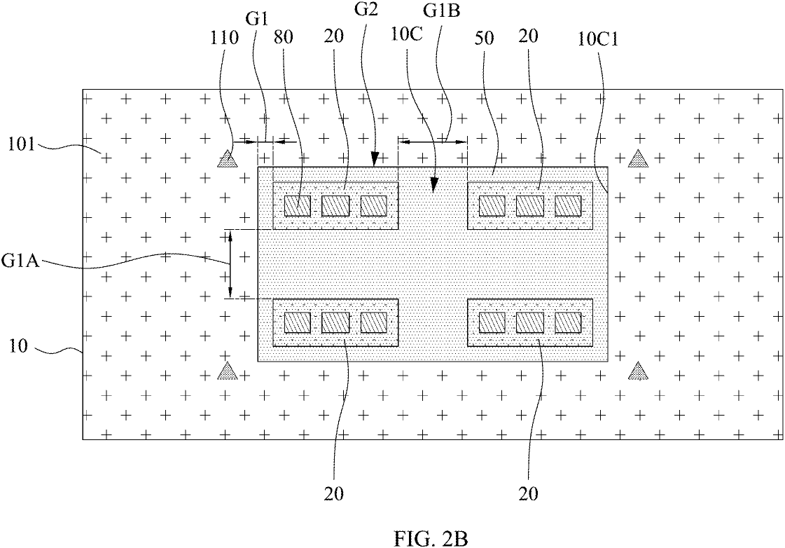

FIG. 2A illustrates a top view of a photonic package 1 in accordance with some embodiments of the present disclosure. It should be noted that some components are omitted in FIG. 2A for clarity.

In some embodiments, the carrier 10 includes a plurality of cavities 10C, and each of the electronic components 20 is disposed in one of the cavities 10C. In some embodiments, the gap G1 surrounds the electronic component 20 in the cavity 10C. In some embodiments, the gap G2 is connected to and covers the gap G1. In some embodiments, a portion of the filling material 50 filled in the gap G2 covers the electronic component 20 and the gap G1 from a top view perspective. In some embodiments, a portion of the filling material 50 filled in the gap G1 surrounds the electronic component 20.

FIG. 2B illustrates a top view of a photonic package 1 in accordance with some embodiments of the present disclosure. It should be noted that some components are omitted in FIG. 2B for clarity.

In some embodiments, a plurality of electronic components 20 are disposed in one cavity 10C of the carrier 10. In some embodiments, the adjacent electronic components 20 are spaced apart from each other by a gap G1A or G1B. A dimension (e.g., width or depth) of the gap G1A may be the same as or different from a dimension (e.g., width or depth) of the gap G1B. In some embodiments, a dimension (e.g., width or depth) of the gap G1 may be the same as or different from a dimension (e.g., width or depth) of the gap G1A and/or the gap G1B. In some embodiments, the filling material 50 is filled in the gaps G1, G1A, and G1B. In some embodiments, the gap G2 is connected to and covers the gaps G1, G1A, and G1B. In some embodiments, a portion of the filling material 50 filled in the gap G2 covers the electronic component 20 and the gaps G1, G1A, and G1B from a top view perspective.

In some embodiments, the photonic package 1 further includes one or more alignment marks 110 on the surface 101 of the carrier 10. In some embodiments, the alignment mark 110 is located adjacent to a corner of the cavity 10C. In some embodiments, four alignment marks 110 are located adjacent to four corners of the cavity 10C of the carrier 10. In some embodiments, the alignment mark 110 is located adjacent to a position at which an electronic component 20 is disposed. For example, the electronic components 20 are disposed at the corners of the cavity 10C of the carrier 10, and the alignment marks 110 are located at the positions of the surface 101 adjacent to and/or corresponding to the corners of the cavity 10C at which the electronic components 20 are disposed.

According to some embodiments of the present disclosure, with the design of the alignment marks 110, the alignment accuracy of the pick and place operation of the electronic components 20 can be increased, each of the electronic components 20 can be disposed at its predetermined position in the cavity 10C of the carrier 10 more accurately, damages caused by collisions between the electronic components 20 during the pick and place operation can be effectively prevented, and thus the yield can be increased.

FIG. 3A illustrates a cross-sectional view of a photonic package 3A in accordance with some embodiments of the present disclosure. The photonic package 3A is similar to the photonic package 1 in FIG. 1, and the differences therebetween are described as follows.

In some embodiments, the photonic package 3A further includes an underfill 94. In some embodiments, the photonic component 30 further includes an optical component 320 and the photonic package 3A may further include an optical component 330, which is optically coupled to the optical component 320 of the photonic component 30.

In some embodiments, the optical component 320 is disposed on or proximal to the surface 301 (also referred to as “the active surface”) of the photonic component 30. In some embodiments, the optical component 320 is embedded in the photonic component 30. In some embodiments, the optical component 320 is optically coupled to the optical component 330. In some embodiments, the optical component 320 is configured to transmit optical signals (e.g., light), for example, received from a laser diode, an optical fiber or an optical fiber array. In some embodiments, the optical component 320 includes a waveguide.

In some embodiments, the optical component 330 is optically coupled to the photonic component 30, e.g., the optical component 320 of the photonic component 30. In some embodiments, the optical component 330 is configured to transmit or receive optical signals. In some embodiments, the optical component 330 is disposed over the RDL 40. In some embodiments, an edge (e.g., at least a portion of a lateral surface 303) of the photonic component 30 defines a space or a recess configured to accommodate the optical component 330. In some embodiments, the optical component 330 contacts the lateral surface 303 of the photonic component 30 and optically coupled to the optical component 320 of the photonic component 30 exposed from the lateral surface 303. In some embodiments, the optical component 330 includes one or more optical fibers or laser diode. In some embodiments, the optical component 330 includes an optical fiber array unit or an optical fiber array unit surrounding by a housing. In some embodiments, the optical component 320 may be or include a waveguide, and the optical component 330 may be an optical fiber array unit or an optical fiber array unit surrounding by a housing.

In some embodiments, the underfill 94 encapsulates or covers the conductive elements 70. In some embodiments, the underfill 94 encapsulates or covers the conductive elements 70 and the conductive pads 310. In some embodiments, the underfill 94 is spaced apart from the optical component 320. In some embodiments, the underfill 94 is spaced apart from the optical component 330 by a gap between the optical component 320 and the RDL 40 and/or a gap between the optical component 320 and a conductive pad 310 adjacent to the optical component 320. In some embodiments, the photonic package 3A does not include an encapsulant; however, in some other embodiments, the photonic package 3A may include an encapsulant 92 as illustrated in FIG. 1. In some embodiments, the underfill 94 includes an epoxy resin, a molding compound (e.g., an epoxy molding compound or other molding compound), polyimide, a phenolic compound or material, a material including a silicone dispersed therein, or a combination thereof. According to some embodiments of the present disclosure, with the arrangement of the gap between the optical component 320 and the RDL 40 and/or the gap between the optical component 320 and a conductive pad 310 adjacent to the optical component 320, the underfill 94 can be prevented from overflowing towards the optical coupling region where the optical component 320 (e.g., waveguide) of the photonic component 30 is optically coupled to the optical component 330 (e.g., optical fiber array unit). Therefore, the optical coupling of the photonic component 30 to the optical component 330 can be prevented from deteriorating or failing.

FIG. 3B illustrates a cross-sectional view of a photonic package 3B in accordance with some embodiments of the present disclosure. The photonic package 3B is similar to the photonic package 1 in FIG. 1, and the differences therebetween are described as follows.

In some embodiments, the electronic component 20 and the electronic component 20’ are both disposed below the surface 101 of the carrier 10. In some embodiments, the electronic component 20 and the electronic component 20’ are embedded in the carrier 10. In some embodiments, the carrier 10 includes two cavities 10C exposed from the surface 101 of the carrier 10, and the electronic component 20 and the electronic component 20’ are each disposed in one of the two cavities 10C of the carrier 10. In some embodiments, the electronic component 20 and the electronic component 20’ have different dimensions. In some embodiments, the electronic component 20 and the electronic component 20’ have different thicknesses. In some embodiments, a thickness T2 of the electronic component 20' is greater than a thickness T1 of the electronic component 20. In some embodiments, the electronic component 20 and the electronic component 20’ have different widths. In some embodiments, a width W2 of the electronic component 20’ is less than a width W1 of the electronic component 20.

In some embodiments, the photonic component 30 is disposed over the surface 101 of the carrier 10, and the RDL 40 electrically connects the photonic component 30 to the electronic component 20 and the electronic component 20'.

In some embodiments, the photonic package 3B includes a first set of conductive elements 80 and a second set of conductive elements 80'. In some embodiments, the conductive elements 80 connect the electronic component 20 to the RDL 40, and the conductive elements 80' connect the electronic component 20' to the RDL 40. In some embodiments, a thickness T3 of the conductive elements 80 is different from a thickness T4 of the conductive elements 80'. In some embodiments, the RDL 40 contacts the surface 101 of the carrier 10, the conductive elements 80, and the conductive elements 80’. In some embodiments, upper surfaces of the conductive elements 80 and upper surfaces of the conductive elements 80’ are substantially coplanar.

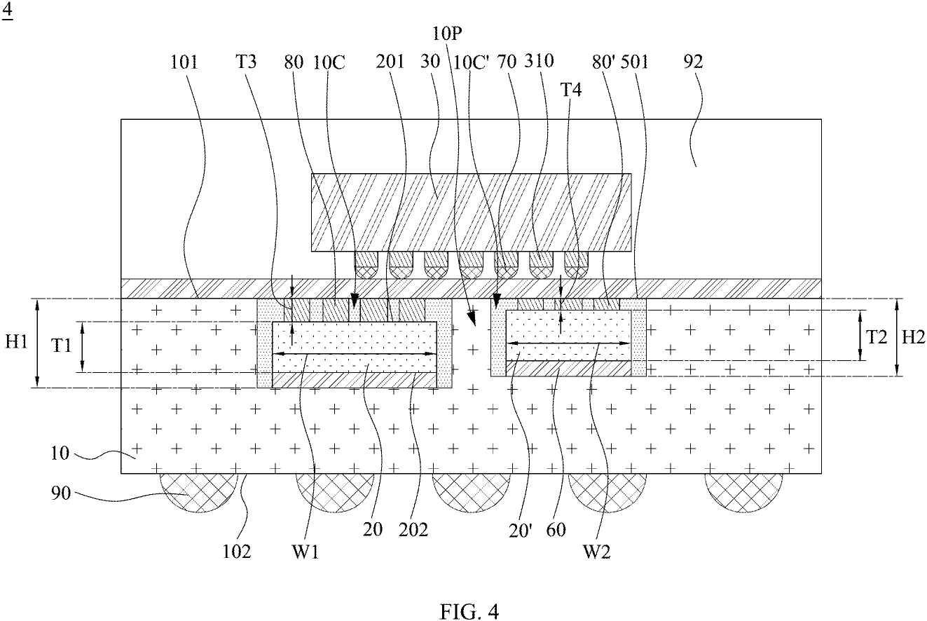

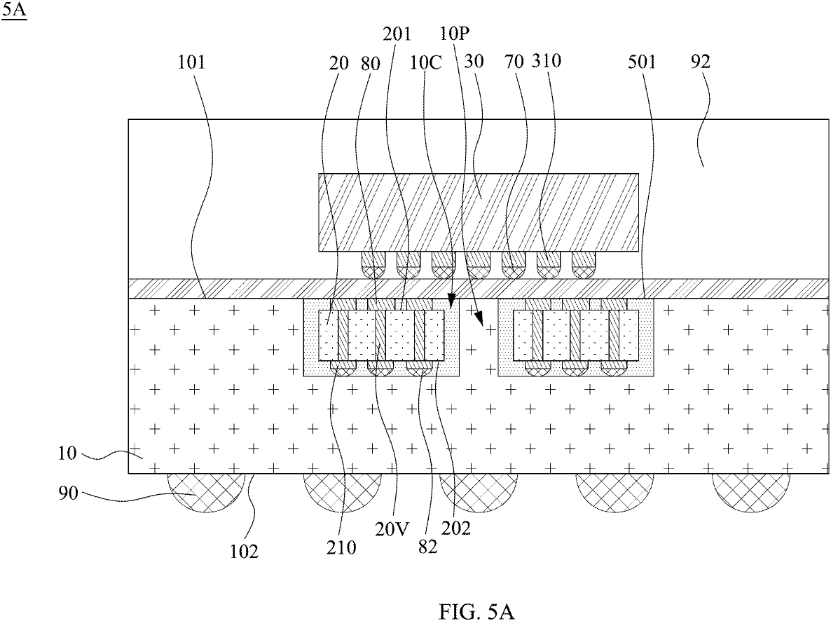

FIG. 4 illustrates a cross-sectional view of a photonic package 4 in accordance with some embodiments of the present disclosure. The photonic package 4 is similar to the photonic package 1 in FIG. 1, and the differences therebetween are described as follows.

In some embodiments, the carrier 10 includes at least two cavities 10C and 10C' exposed from the surface 101 of the carrier 10, and the at least two cavities 10C and 10C' have different depths. In some embodiments, a depth H1 of the cavity 10C is greater than a depth H2 of the cavity 10C. In some embodiments, a bottom surface of the cavity 10C and a bottom surface of the cavity 10C' are at different elevations. In some embodiments, the electronic components 20 and 20' are disposed in the cavities 10C and 10C', respectively. In some embodiments, the thickness T1 of the electronic components 20 in the cavity 10C is different from the thickness T2 of the electronic components 20' in the cavity 10C'. In some embodiments, the thickness T3 of the conductive elements 80 in the cavity 10C is different from the thickness T4 of the conductive elements 80' in the cavity 10C'. In some embodiments, upper surfaces of the conductive elements 80 and 80' are substantially coplanar.

According to some embodiments of the present disclosure, with the design of the carrier 10 having cavities 10C and 10C' for accommodating the electronic components 20 and 20', the depths H1 and H2 of the cavities 10C and 10C' can vary according to the sizes and/or the thicknesses of the various electronic components 20 and 20'. Therefore, the flexibility of the arrangement of the electronic components 20 can be increased, while the overall thickness of the photonic package 4 can be reduced.

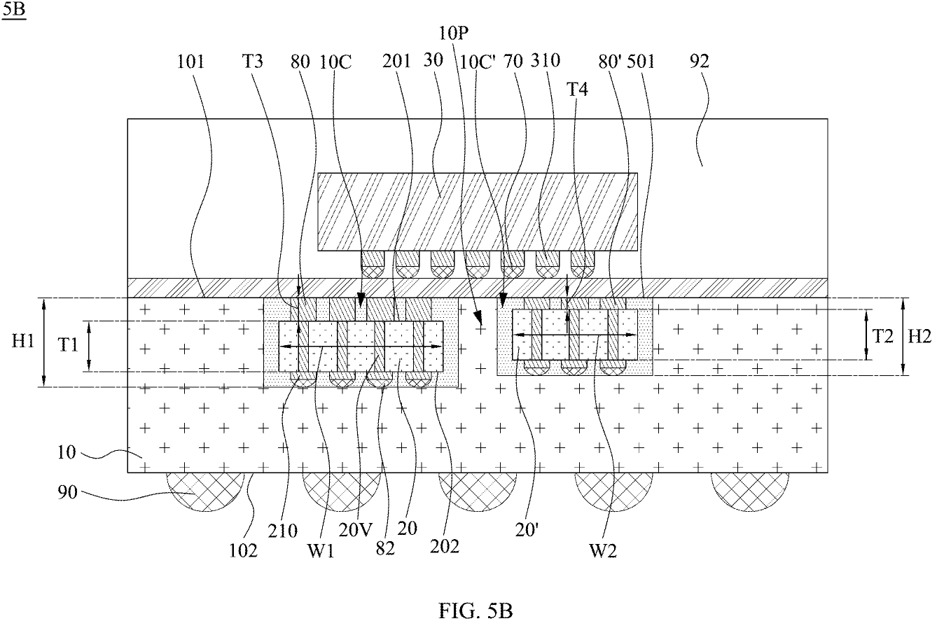

FIG. 5A illustrates a cross-sectional view of a photonic package 5A in accordance with some embodiments of the present disclosure. The photonic package 5A is similar to the photonic package 1 in FIG. 1, and the differences therebetween are described as follows.

In some embodiments, the electronic component 20 includes at least one conductive through via 20V electrically connected to the bottom surface of the cavity 10C of the carrier 10. In some embodiments, the conductive through via 20V is electrically connected to the conductive element 80. In some embodiments, the electronic component 20 may include one or more conductive pads 210 in proximity to, adjacent to, or embedded in and exposed at the surface 202 of the electronic component 20 for electrical connections. In some embodiments, the conductive through via 20V is electrically connected to the conductive pad 210.

In some embodiments, the photonic package 5A further includes one or more conductive elements 82. In some embodiments, the conductive elements 82 electrically connect the conductive through vias 20 V to the bottom surface of the cavity 10C. In some embodiments, the electronic component 20 is electrically connected to the carrier 10 through the conductive elements 82. In some embodiments, the electronic component 20 is electrically connected to the carrier 10 through the conductive through vias 20 V, the conductive pads 210, and the conductive elements 82. In some embodiments, the conductive elements 82 may include conductive bumps or solder balls. In some embodiments, a pitch of the conductive elements 82 is from about 25 µm to about 55 µm.

According to some embodiments of the present disclosure, with the design of the conductive through via 20V in the electronic component 20, the electronic component 20 can be attached and electrically connected to the bottom surface of the cavity 10C of the carrier 10 through the conductive elements 82. Therefore, compared to the cases where the electronic component 20 is electrically connected to the carrier 10 through the RDL 40, the arrangements of the conductive through via 20V and the conductive elements 82 significantly reduce the conductive path between the electronic component 20 and the carrier 10.

FIG. 5B illustrates a cross-sectional view of a photonic package 5B in accordance with some embodiments of the present disclosure. The photonic package 5B is similar to the photonic package 5A in FIG. 5A, and the differences therebetween are described as follows.

In some embodiments, the depth H1 of the cavity 10C of the carrier 10 is different from the depth H2 of the cavity 10C', for example, a depth H1 of the cavity 10C is greater than a depth H2 of the cavity 10C'. In some embodiments, the thickness T1 of the electronic components 20 in the cavity 10C is different from the thickness T2 of the electronic components 20' in the cavity 10C'. In some embodiments, the thickness T3 of the conductive elements 80 in the cavity 10C is different from the thickness T4 of the conductive elements 80' in the cavity 10C'.

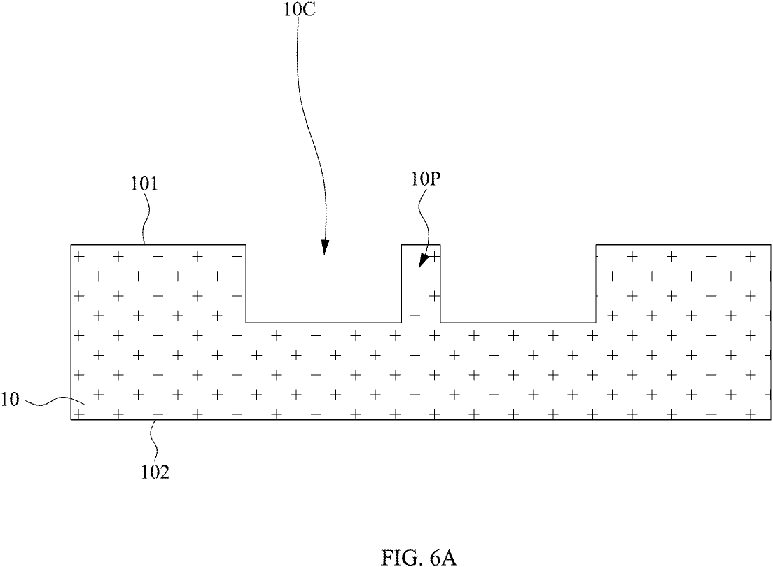

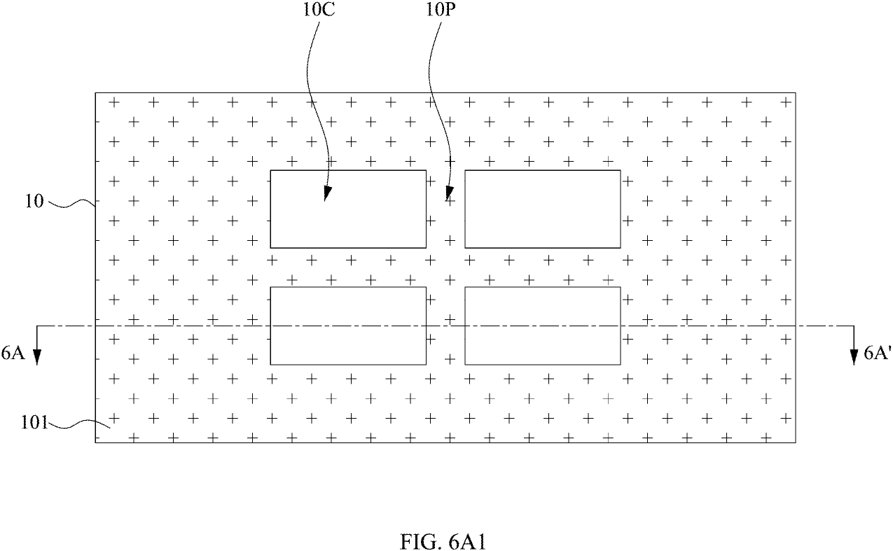

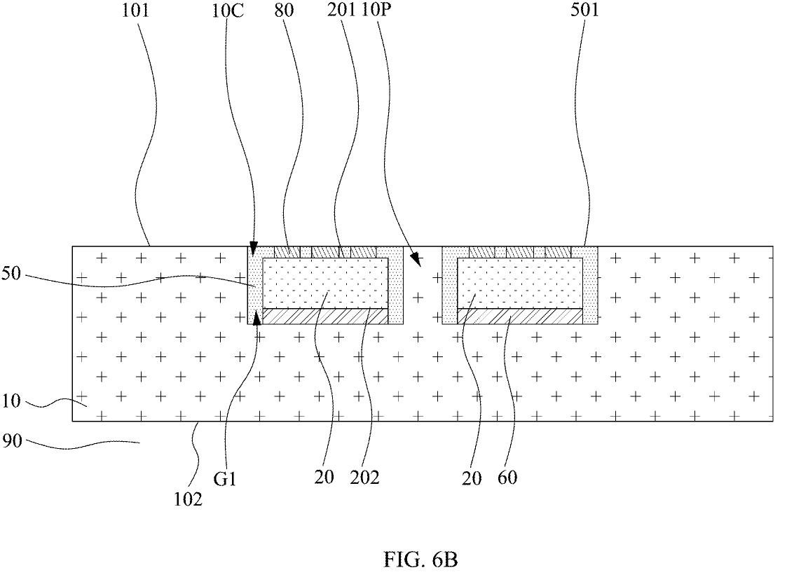

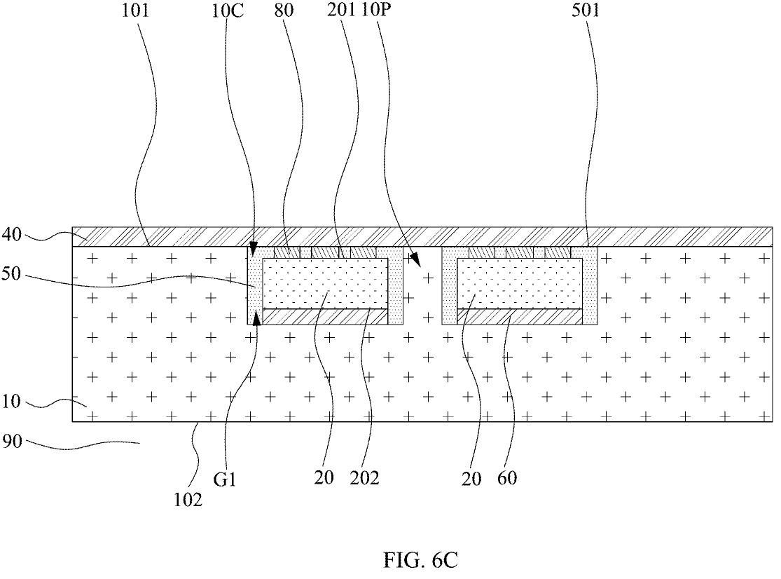

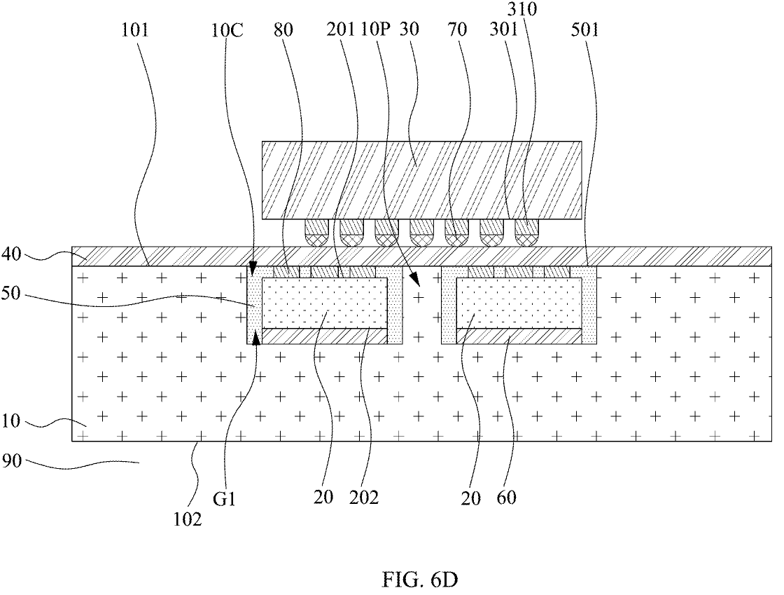

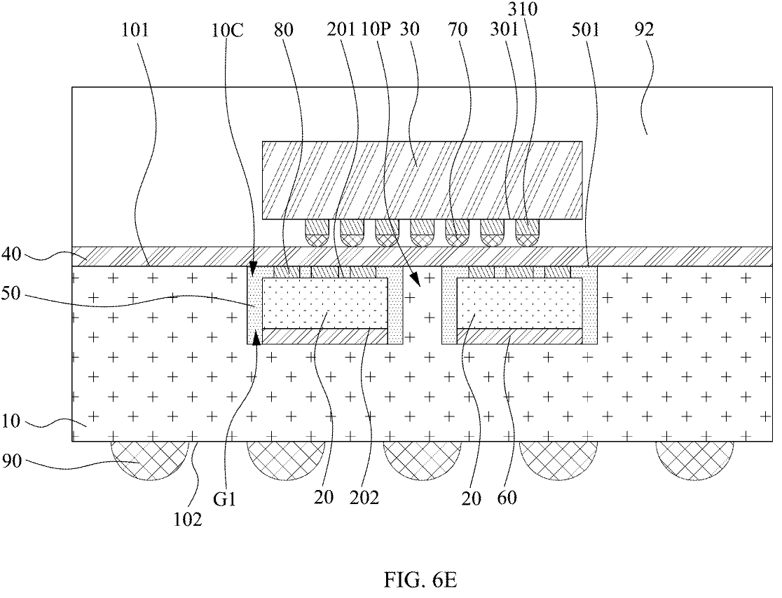

FIG. 6A, FIG. 6A1, FIG. 6B, FIG. 6C, FIG. 6D, and FIG. 6E illustrate various operations in a method of manufacturing a photonic package 1 in accordance with some embodiments of the present disclosure.

Referring to FIG. 6A, a carrier 10 may be provided. In some embodiments, the carrier 10 has a surface 101 and a surface 102 opposite to the surface 101, and the carrier 10 includes one or more cavities 10C exposed from the surface 101 of the carrier 10. In some embodiments, the cavities 10C may be formed by drilling, stamping, or other suitable operations. The formation operation for the cavities 10C may vary according to actual applications, and the present disclosure is not limited thereto.

Referring to FIG. 6A1, the carrier 10 may include a plurality of cavities 10C exposed from the surface 101 of the carrier 10. In some embodiments, FIG. 6A illustrates a cross-sectional view along the cross-sectional line 6A-6A’ in FIG. 6A1.

Referring to FIG. 6B, one or more electronic components 20 may be disposed within the carrier 10 and below the surface 101 of the carrier 10, and a filling material 50 may be disposed to encapsulate the electronic component 20. In some embodiments, the electronic component 20 is disposed in the cavity 10C of the carrier 10. In some embodiments, the electronic component 20 is attached to a bottom surface of the cavity 10C through an adhesive layer 60. In some embodiments, one or more conductive elements 80 are disposed or formed on active surface 201 of the electronic component 20. In some embodiments, the conductive elements 80 may be disposed or formed on active surface 201 of the electronic component 20 prior to placing the electronic component 20 in the cavity 10C. In some embodiments, the filling material 50 is disposed in the cavity 10C to encapsulate the electronic component 20. In some embodiments, the filling material 50 covers a portion of the active surface 201 of the electronic component 20. In some embodiments, a planarization operation may be performed on the conductive elements 80 and the filling material 50, such that upper surfaces of the conductive elements 80, an upper surface 501 of the filling material 50, and the surface 101 of the carrier 10 are substantially coplanar. In some embodiments, the planarization operation may be performed by grinding.

Referring to FIG. 6C, an RDL 40 may be formed on the electronic component 20 and the surface 101 of the carrier 10. In some embodiments, the RDL 40 is formed on and electrically connected to the conductive elements 80. In some embodiments, the electronic component 20 is electrically connected to the carrier 10 via the RDL 40. In some embodiments, the RDL 40 is further formed on the filling material 50. In some embodiments, the electronic components 20 are disposed in the cavities 10C prior to forming the RDL 40.

Referring to FIG. 6D, a photonic component 30 may be disposed on the RDL 40. In some embodiments, the photonic component 30 is electrically connected to the electronic component 20 through the RDL 40. In some embodiments, a plurality of conductive elements 70 are disposed on the RDL 40 to electrically connect the active surface 201 of the photonic component 20 to the conductive elements 70. In some embodiments, conductive pads 310 of the photonic component 30 are bonded to the conductive element 70 to electrically connect the photonic component 30 to the RDL 40.

Referring to FIG. 6E, the photonic component 30, conductive pads 310 of the photonic component 30 and the conductive elements 70 are encapsulated with an encapsulant 92. As such, the photonic package 1 illustrated in FIG. 1 is formed.

In some other embodiments, after the operations illustrated in FIGS. 6A-6D are performed, referring to FIG. 3A, an underfill 94 is formed to encapsulate the conductive pads 310 and the conductive element 70, an optical component 320 is disposed on or proximal to the surface 301 of the photonic component 30, and an optical component 330 is connected to the optical component 320. As such, the photonic package 3A illustrated in FIG. 3A is formed.

In some other embodiments, in the operations illustrated in FIG. 6A, a carrier 10 having one cavity 10C may be provided, referring to FIG. 2B, and alignment marks 110 may be formed on the surface 101 of the carrier 10 prior to performing operations similar to those illustrated in FIGS. 6B-6E. Therefore, the alignment marks 110 can be advantageous to increasing the alignment accuracy of disposing the electronic components 20 in the cavity 10C of the carrier 10.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of said numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” or “about” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” parallel can refer to a range of angular variation relative to 0° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 µm, no greater than 2 µm, no greater than 1 µm, or no greater than 0.5 µm.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

As used herein, the singular terms “a,” “an,” and “the” may include plural referents unless the context clearly dictates otherwise. In the description of some embodiments, a component provided “on” or “over” another component can encompass cases where the former component is directly on (e.g., in physical contact with) the latter component, as well as cases where one or more intervening components are located between the former component and the latter component.

While the present disclosure has been described and illustrated with reference to specific embodiments thereof, these descriptions and illustrations do not limit the present disclosure. It can be clearly understood by those skilled in the art that various changes may be made, and equivalent components may be substituted within the embodiments without departing from the true spirit and scope of the present disclosure as defined by the appended claims. The illustrations may not necessarily be drawn to scale. There may be distinctions between the artistic renditions in the present disclosure and the actual apparatus, due to variables in manufacturing processes and the like. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it can be understood that these operations may be combined, sub-divided, or re-ordered to form an equivalent method without departing from the teachings of the present disclosure. Therefore, unless specifically indicated herein, the order and grouping of the operations are not limitations of the present disclosure.

What is claimed is:

1. A photonic package, comprising:
a carrier having a first surface and a recess portion exposed from the first surface;
an electronic component disposed in recessed portion; and
a photonic component disposed on and electrically connected to the electronic component and configured to communicate optical signals.

2. The photonic package as claimed in claim 1, wherein the recess portion comprises a cavity exposed from the first surface of the carrier, and the electronic component is disposed in the cavity.

3. The photonic package as claimed in claim 2, wherein the electronic component is spaced apart from a sidewall of the cavity by a gap, and the photonic package further comprises a filling material disposed in the gap.

4. The photonic package as claimed in claim 2, further comprising a filling material encapsulating the electronic component, wherein a surface of the filling material is substantially aligned with the first surface of the carrier.

5. The photonic package as claimed in claim 1, further comprising a redistribution layer (RDL) disposed over the electronic component.

6. The photonic package as claimed in claim 5, wherein the electronic component has an active surface electrically connected to the RDL and spaced apart from the RDL by a gap, and the photonic package further comprises a filling material disposed in the gap.

7. The photonic package as claimed in claim 6, wherein the first surface of the carrier and the active surface of the electronic component are at different elevations.

8. The photonic package as claimed in claim 5, wherein the RDL contacts the first surface of the carrier.

9. The photonic package as claimed in claim 1, wherein the recess portion comprises a cavity exposed from the first surface of the carrier, and the photonic package further comprises a plurality of the electronic components disposed in the cavity.

10. The photonic package as claimed in claim 9, further comprising at least one alignment mark located adjacent to at least one corner of the cavity.

11. The photonic package as claimed in claim 1, wherein the recess portion comprises a cavity exposed from the first surface of the carrier, and the electronic component comprises at least one conductive through via electrically connected to a bottom surface of the cavity.

12. A photonic package, comprising:
a carrier;
a first electronic component disposed in the carrier;
a second electronic component disposed in the carrier, wherein a thickness of the first electronic component is different from a thickness of the second electronic component; and
a photonic component disposed on the carrier, electrically connected to the first electronic component and the second electronic component, and configured to communicate optical signals.

13. The photonic package as claimed in claim 12, wherein the carrier comprises a first cavity and a second cavity exposed from a first surface of the carrier, and the first electronic component and the second electronic component are respectively disposed in the first cavity and the second cavity.

14. The photonic package as claimed in claim 13, wherein the first cavity and the second cavity have different depths.

15. The photonic package as claimed in claim 12, further comprising a redistribution layer (RDL) electrically connecting the photonic component to the first electronic component and the second electronic component.

16. The photonic package as claimed in claim 15, further comprising a first set of conductive elements connecting the first electronic component to the RDL and a second set of conductive elements connecting the second electronic component to the RDL, wherein a thickness of the first set of conductive elements is different from a thickness of the second set of conductive elements.

17. A photonic package, comprising:
a carrier comprising at least one cavity exposed from an upper surface of the carrier;
a first electronic component disposed in the at least one cavity of the carrier, the first electronic component being configured to control modulation of optical signals; and
a second electronic component disposed in the at least one cavity of the carrier, the second electronic component being configured to amplify electrical signals.

18. The photonic package as claimed in claim 17, further comprising:
a photonic component disposed adjacent to the upper surface of the carrier, the photonic component being configured to communicate optical signals.

19. The photonic package as claimed in claim 18, wherein the photonic component comprises:
a first optical component configured to transmit a light and optically coupled to a second optical component.

20. The photonic package as claimed in claim 18, further comprising:
a redistribution layer (RDL) disposed between the photonic component and the first electronic component and the second electronic component.
